(19) United States
(12) Patent Application Publication
(10) Pub. No.: US 2026/0119557 A1
(43) Pub. Date: Apr. 30, 2026

(54) SYSTEM AND METHOD FOR NATURAL LANGUAGE PROCESSING WITH FORMATTED DATA

(71) Applicant: ROYAL BANK OF CANADA, Toronto (CA)

(72) Inventors: Patricia AROCENA, Toronto (CA); Solaiappan ALAGAPPAN, Toronto (CA); Jerry GEORGE, Toronto (CA); Tony LEE, Toronto (CA); Prince Jayeshkumar PATEL, Toronto (CA); Sijie TIAN, Toronto (CA)

(21) Appl. No.: 19/374,937

(22) Filed: Oct. 30, 2025

Related U.S. Application Data
(60) Provisional application No. 63/713,894, filed on Oct. 30, 2024.

(51) Int. Cl. G06F 16/334; G06F 16/22

(52) U.S. Cl. CPC G06F 16/3347; G06F 16/2237

(57) ABSTRACT

Disclosed herein are methods and systems for a computer-implemented natural language processing architecture. A method can include receiving or accessing an electronic document; traversing the electronic document to identify at least one structural indicator associated with a portion of the electronic document; manipulating the electronic document to generate an augmented electronic document encapsulating a semantic associated with the structural indicator; and storing the augmented electronic document in a vector database.

### CROSS-REFERENCE TO RELATED APPLICATION

This application claims all benefit of, including priority to, U.S. Provisional Patent Application No. 63/713,894, filed Oct. 30, 2024, and entitled “SYSTEM AND METHOD FOR NATURAL LANGUAGE PROCESSING WITH FORMATTED DATA”, the entirety of which is hereby incorporated by reference.

### FIELD

Embodiments of the present disclosure relate generally to the field of natural language processing, and some embodiments particularly relate to systems, methods and devices for natural language processing of electronic documents with formatted data.

### INTRODUCTION

Natural language processing architectures and, in particular, large language models can be used to process large volumes of documents. However, when searching for precise pieces of information in similarly-worded documents, or where context can be lost in the formatting of a document, properly capturing semantics and extract a correct response can be a challenge.

### SUMMARY

In some embodiments, aspects of the systems and methods described herein can capture semantics based on the formatting of a document which may not be properly encapsulated by other natural language processing architectures.

In accordance with one aspect, there is provided a method for a computer-implemented natural language processing architecture. The method includes receiving or accessing an electronic document; traversing the electronic document to identify at least one structural indicator associated with a portion of the electronic document; manipulating the electronic document to generate an augmented electronic document encapsulating a semantic associated with the structural indicator; and storing the augmented electronic document in a vector database.

In some of embodiments, at least one structural indicator includes at least one of: an indicator indicative of a table; an indicator indicative of a document heading or a section of the electronic document; an indicator indicative of a list of steps or conditions; or an indicator indicative of metadata associated with the electronic document.

In some of embodiments, the method includes identifying a structural indicator indicative of a table, the table including a heading row and at least one non-heading row; and for each non-heading row of a table, generating augmented text including data from the non-heading row and data from the heading row.

In some embodiments, the method includes identifying a structural indicator indicative of a multi-level (e.g. nested or sub-tables); and for each non-heading row of the table, recursively traversing each level of the table to generate augmented text including data from the non-heading row and data from the headings of each corresponding level of the table.

In some embodiments, the method includes: identifying one or more structural indicators indicative of a plurality of sections in the electronic document; and segmenting the electronic document into dynamically-sized basic blocks based at least in part on boundaries between the plurality of sections.

In some embodiments, the method includes generating embeddings for segments of the augmented electronic document using a plurality of models.

In some embodiments, the method includes receiving a query via a user interface or front-end application; generating query embeddings based on the text query; obtaining document embeddings from the vector database based on the query embeddings; and communicating a query response base on the obtained document embeddings.

In some embodiments, the method includes determining a user type associated with the query; and obtaining document embeddings based at least in part on the user type.

In accordance with another aspect, there is provided a non-transitory computer-readable medium or media having stored thereon machine interpretable instructions which, when executed by a processing system, cause the processing system to perform the method embodiments above or otherwise described herein.

### BRIEF DESCRIPTION OF THE FIGURES

FIG. 1 is a schematic diagram showing aspects of a computer system and data flows for an example natural language processing architecture.

FIG. 2 is a data flow diagram showing aspects of an example data ingestion method.

FIG. 3 is a schematic diagram showing aspects of a computer system and data flows for an example information retrieval method.

FIG. 4 is a data flow diagram showing aspects of an example data generative answering method.

FIG. 5 is an example graphical user interface showing a query and resulting output.

FIG. 6 shows two views of an example electronic document.

FIG. 7 shows a portion of an example electronic document with a table of steps.

FIG. 8 shows a portion of an example electronic document with a table having rows with different numbers of columns.

FIG. 9 is a flow chart showing aspects of an example method.

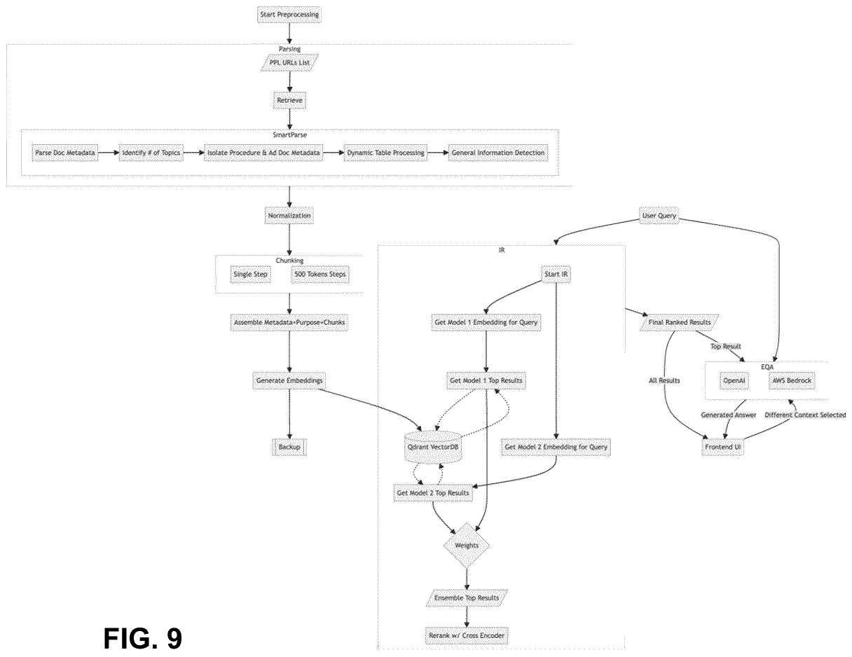

FIG. 10 is a schematic diagram showing aspects of an example computing device.

FIG. 11 is a flow chart showing aspects of an example method.

These drawings depict exemplary embodiments for illustrative purposes, and variations, alternative configurations, alternative components and modifications may be made to these exemplary embodiments.

### DETAILED DESCRIPTION

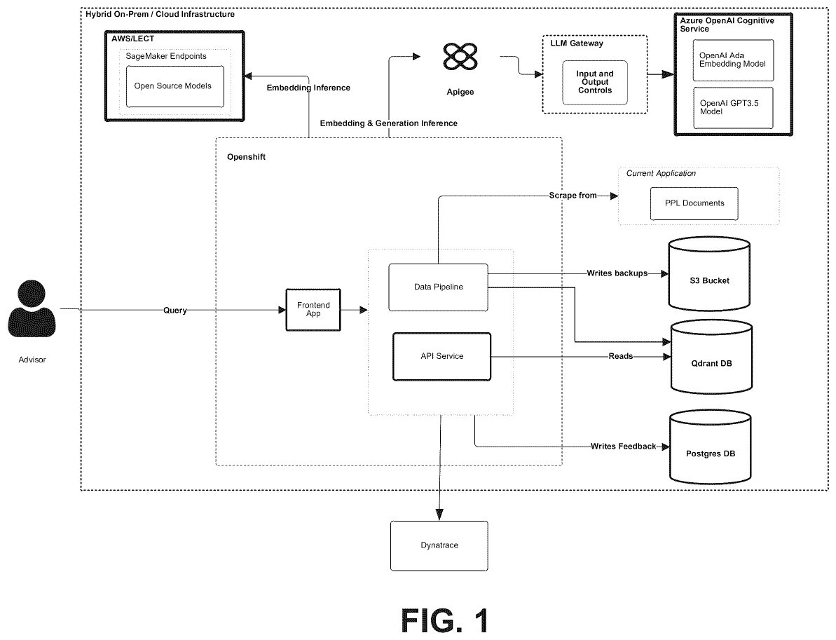

FIG. 1 shows aspects of an example computer system for a natural language processing architecture.

In some embodiments, the system can provide a knowledge retrieval system which may, in some situations, extract more accurate information when the underlying electronic repository includes information in similarly-worded documents and/or where context can be lost in the formatting of a document. In some situations, aspects of the system can improve the capturing semantics based on the electronic structure or formatting of a document.

In some embodiments, the system can traverse or otherwise parse an electronic document and manipulate the document to generate an augmented electronic document which can help the natural language architecture to encapsulated semantics associated with structural indicators in the document.

In some embodiments, the system can provide a user interface to receive queries for the knowledge retrieval system. In some embodiments, the system can allow a user to use natural language to ask questions, retrieving results based on the user's role, intent, and context, and removing the need for word stringing or keyword search.

In one example application, an enterprise knowledge repository may house all enterprise documents such as frameworks, policies, procedures, standing orders, standards, and all the mandatory requirements for business or functional units across the organization. For a large organization, this can include over 30,000 written policies and procedures and may cover documents for operations across multiple divisions of an institution.

In some situations, the application of generative AI may involve risks relating to customer or proprietary data, hallucinations, and prompt injections, and aspects of the present embodiments may address or mitigate some of these risks.

In other knowledge management systems, searching is done by keyword which depending on the query can provide less relevant results, resulting in more time spent by the user on finding the desired document or information. This can be costly in terms of user time as well as the amount of online time/resources being tied up for example when spending time searching when on a call with a customer. In an illustrative example, banking advisors may be required to search by stringing together specific keywords, such as “CASH MONEY CURRENCY” to have the best chance of finding what they are looking for. Other words carry a strong connotation when grouped together, such as “balance statement”. Searching a large financial document repository for “BALANCE STATEMENT” may retrieve documents that have the keyword BALANCE, the keyword STATEMENT, but there may be no mechanism to infer the meaning created when these two words are searched together in this order. Furthermore, keyword search may only return documents indexed with the keywords being searched (or close variations of them), failing to consider documents in the repository where the overall semantic meaning matches the advisor's query.

In some situations, aspects of the present system may enable a reduction in search and support activities and may enable advisors to handle more calls, reducing computer usage, increasing advisor efficiency while reducing more manual efforts.

This may also result in a reduction in call-wait times and potential transfers to another specialist while delivering more accurate and relevant information, and reducing load on call servers.

In some situations, aspects of the present system may enable advisors with less training or knowledge of the documents and/or their contents/terminology to successfully utilize the system.

In some embodiments, by leveraging Natural Language Understanding to retrieve and rank results based on user role, intent, and context, aspects of the system and methods described herein may remove the need for word stringing or keyword search.

Take for example, a customer inquiring about a duplicated bill payment within online banking. An advice centre advisor will search the electronic library for what they feel may be the most suitable keywords and the system will return a list of potential procedures documents. Although results may look promising, it may take up to a few minutes to do a manual thorough review of each link provided.

In some embodiments, the system may enable a query to be inputted in natural language to find specific information within a large volume of documents which may have similar keywords throughout. For example, in a document system for a financial system with many policies and procedures over bills, payments and banking activities, searching for keywords may not result in relevant documents or the desired answer. In some situations, aspects of the present system may enable a natural language input such as “Why would a bill payment be duplicated?” rather than keyword hunting.

In some embodiments, as described herein, the system may process the natural language query input and return the information which is extracted from the relevant document. In some embodiments, one or more answers and/or source documents for the answers may be returned. In some embodiments, upon receiving an input selecting one of the answers and/or source documents, the system can display the exact relevant text and/or document from which the answer was extracted.

In some embodiments, the system is configured to autocomplete a user query and/or intent as the query is being inputted. In some embodiments, the system can autocomplete the query in conversational language. This may speed up the inputting of queries and by capturing the intent may result in more precise queries which may lead to better results being returned.

In some embodiments, the answer returned by the system is a generative answer. For example, the automated assistant may formulate a response based on the answer the system was able to find in the relevant passage of the selected matching document. With the generative answer available, the user interface may enable the user to quickly discern whether the answer seems reasonably correct, see the actual text the generated answer was based on, and go back to the source for the full context contained within the source document itself.

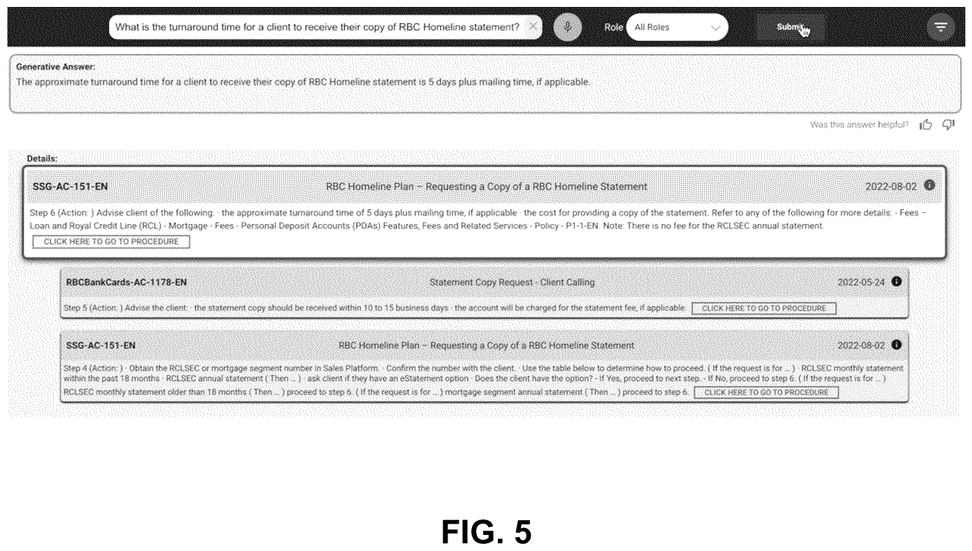

FIG. 5 shows an example user interface illustrating an example natural language query inputted into an input bar, and the resulting output, along with interface elements which when activated enable the user to see the source documents for the returned answers.

In some situations, searching for information and navigating complex policies and procedures today is a lengthy and cumbersome process. Through call listening analysis, it has been observed that advisors can spend up to 38% of their time locating relevant information during a client call. In some embodiments, the system can help advisors find answers faster.

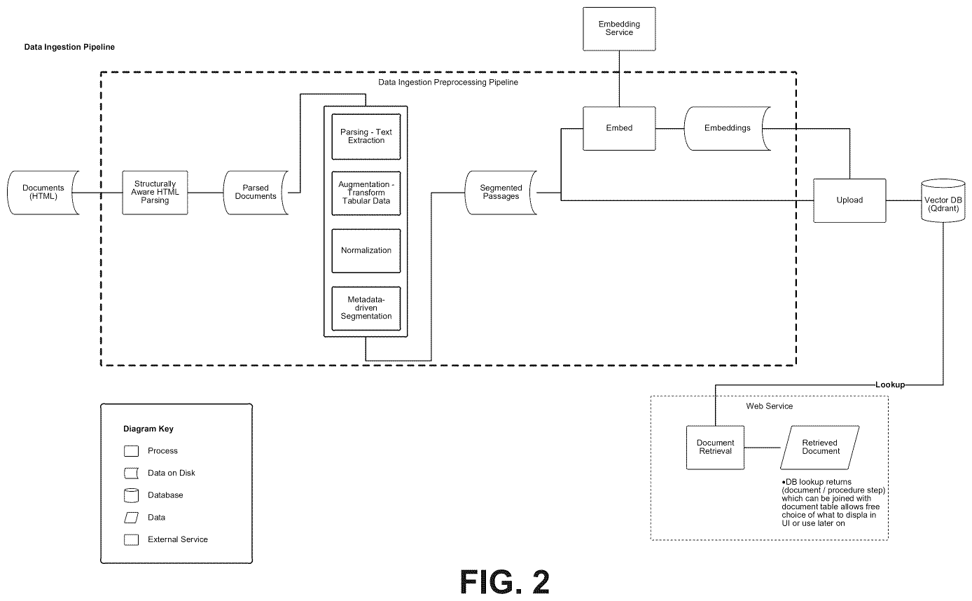

FIG. 2 is a schematic diagram showing example data flows and aspects of a system for generating a vector database encapsulating augmented electronic documents.

In some embodiments, the system is configured for receiving or accessing an electronic document; traversing the electronic document to identify at least one structural indicator associated with a portion of the electronic document; manipulating the electronic document to generate an augmented electronic document encapsulating a semantic associated with the structural indicator; and storing the augmented electronic document in a vector database.

In some embodiments, the system is configured to parse or otherwise traverse an electronic document. In some situations, the electronic document is a document contains information which is to be used as a data source for responding to queries. In some embodiments, the electronic document can be in various formats which include metadata and/or document formatting or structural information. For example, the electronic document may be in HTML, XML, LaTex, doc, docx, pdf or other suitable formats.

In some embodiments, processing a document can include:
Parsing (which can include, for example, converting HTML to python objects)
Preprocessing (which can include, for example, Normalization, adding metadata, chunking into blocks)
Embedding blocks
Upload data to vector database

In some embodiments, traversing the document can include parsing the document into a Python™ or other suitable document format for subsequent processing by the natural language processing system.

In some embodiments, traversing the document can include identifying metadata such as titles, document numbers, document types, publication dates, language, categories, etc. In some embodiments, this metadata can be within the document file itself (e.g. in HTML or XML header or other fields). In some embodiments, metadata can be based on the location of file (e.g. folder/database location) or other file system, database or other metadata/information that is not stored within the document itself.

In some embodiments, traversing the document can include identifying structural indicators(s). In some embodiments, structural indicators can be fields, hidden characters, objects, heading indicators, page breaks, fields, table indicators, or anything in an electronic file which can be indicative of a structural element of the document. Structural elements can be titles, heading, section breaks, page breaks, tables, bullets, styles, punctuation, or any other element which provides structural, visual or otherwise separates portions of text. In some situations, separations of portions of text can provide contextual information with respect to the surrounding text.

The pseudocode below provides an example loop for parsing text in an electronic document. In this example, the pseudocode is for HTML documents accessed via URLs; however, the code can be generalized for other source document types.

Input: urls = list of urls to parse from PPL library (html documents, procedures)
For url in urls:

| | |
|---|---|
| [symbol] page = get_page(url) | #Get page using credentials |
| [symbol] page_content = beautifulsoup(page) | #use html parser from beautifulsoup to extract |

[symbol]

get page metadata from page header

| | |
|---|---|
| | ∘ metadata extracted: title, document number, document type |
| | (procedure / policy / standard or a |
| | combination of them), published date, language, category |
| [symbol] initialize StateManager | #an object to keep track of the current topic and current purpose |

```

[symbol]
  unparsed_text = “”# a string to store text that do not conform
  to the verities of format we capture
```

| | |
|---|---|
| [symbol] abnormal_format = False | #a Boolean flag indicating if the page is abnormally formatted |
| [symbol] page_table = page_content.find(″div″, | #a div is a html tag |

```
  {″class″: ″WordSection1″}) [symbol]
  for child in page_table.children:
```

∘ if child is empty, skip
∘ if child.name == “table” and not abnormal_format: call parse_main_table(child)
∘ if child.name == “table” and abnormal_format: call parse_other_table(child)
∘ else: parse text (get rid of some useless content) then append to unparsed_text

In some embodiments, a document such as, for example, a procedure HTML page, can follow a common format such as where the entire page is stored inside one html “table” tag under a specific div (which in the above example is assigned as page_table). This table should be the only child element of page_table and contains all the information needed. Each row of text displayed corresponds to a row in the table (with invisible table boundaries). In this case, the system executes parse_main_table to get structured objects as output.

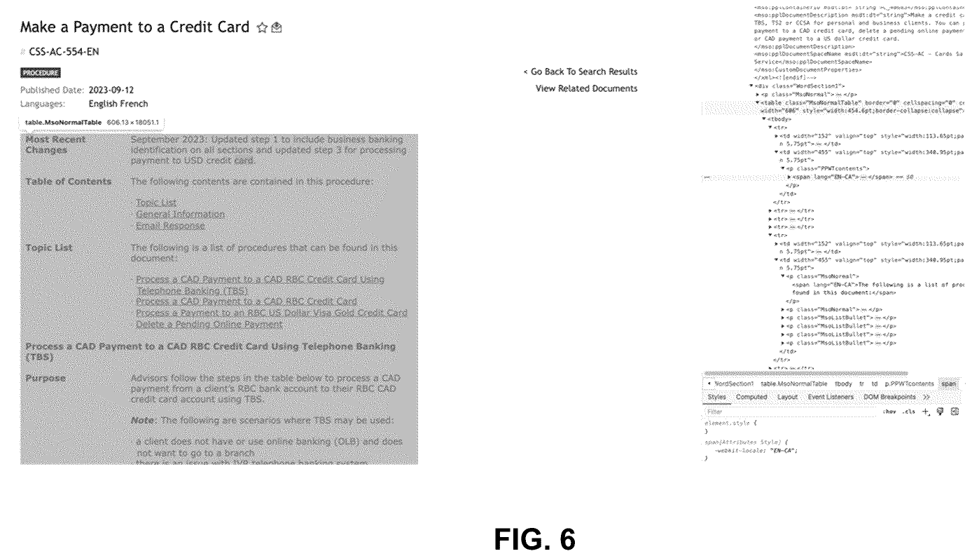

In some embodiments, the system can be configured to detect when a document being traversed is in a typical or atypical format. For example, a typical format can be detected or a document can otherwise be identified as having a typical format when all page content for an HTML document is within a table (which, for example, may have invisible boundaries under ‘WordSection1’). FIG. 6 shows example web document and the corresponding XML electronic document with the table.MsoNormalTable table class.

In some embodiments, the system can be configured to detect other table types (e.g. “parse_other_table”), and a separate process can be executed for these other table types.

In some embodiments, the system can be configured to execute another process for any other format. For example, this process can be triggered when the structural indicators in the electronic document do not match the format for any identified format for which a defined process for that particular format is provided. In some such embodiments, the system is configured to append the text as unparsed text to avoid loss of information.

The following pseudocode shows an example process for parsing a portion of an electronic document when the document is determined to have a known format (such as a typical format).

def parse_main_table(page_table): #contains the bulk of procedure parsing logic for pages with typical format
Input: page_table = all the text in the page, stored inside a single html “table” tag

| [symbol] initialise parsed_rows = [symbol] | | # an empty list to store parsed objects |
|---|---|---|
| [symbol] For row in page_table: | | # a row could contain several cells |
| ∘ | Initilaize parsed_row = [symbol] | # stores parsed content in the current row, could be strings or |
| | ProcedureSteps from a step/action table | |
| ∘ | for cell in row.children: | |
| | if cell contains 1 “table” element: | # typically this is a step/action table |

| | |
|---|---|
| [symbol] | table = HtmlTable(cell) # parse text inside table into an HtmlTable object |
| [symbol] | table_outputs = table.get_outputs( ) # if the table is a step/action table, it returns a |
| | list of ProcedureStep objects. Otherwise it returns all the parsed text |
| | concatenated into 1 string |
| [symbol] | if there's text inside the cell but outside the table, append it too. |
| [symbol] | parsed_row += [text_outside_table + table_outputs] |

| | |
|---|---|
| If cell contains more than one “table” element: | #signals abnormal format |

| | |
|---|---|
| [symbol] | Extract text from each table by calling parse_other_table(each element in cell), |
| | append text to output_str |
| [symbol] | If there's text in the cell but outside tables, append text to output_str |
| [symbol] | Add output_str to parsed_row |

If cell has no table, only text:

| | |
|---|---|
| [symbol] | Add text to parsed_row |

| | |
|---|---|
| ∘ | Add parsed_row to parsed_rows |

| | |
|---|---|
| [symbol] Initialize GI = False | #a flag to indicate if we're in the general information section of page |

```

[symbol]
  Initialize procedures = [symbol]   , procedure_steps = [symbol]   , general_information = [symbol] [symbol]
  Curr = 0 [symbol]
  While curr < len(parsed_rows):
```

| ∘ | if current row has length 1 (contains topic_name), the first element of the next row = “purpose”, the | |
|---|---|---|
| | row after that contains a list of ProcedureSteps: | |
| | - | add previously parsed steps into a procedure: procedure = Procedure(name = curr_topic, |
| | | purpose = curr_purpose, steps = Proceduresteps) |
| | - | procedures.append(procedure) |
| | - | reset procedure steps: procedure_steps = [symbol] |
| | - | update state: curr_topic = topic_name (from current row), curr_purpose = purpose (from |
| | | row_index = curr + 1) |
| | - | curr += 2 |
| ∘ | if curr_row has 2 values, treat as key-value pair: | |
| | - | if key == “definion” or “general information”: |

| [symbol] | add previously parsed steps into a procedure | |
|---|---|---|
| [symbol] | GI = true | #turn flag to true, everything we parse after this will be placed |

| | |
|---|---|
| | into General Information section |
| [symbol] | General_information.append(GeneralInformation(item=key, value=value)) |

| | - | Otherwise depending on the key, we create constructs to store them or skip the row for |
|---|---|---|
| | | the case of useless strings. |
| | - | Curr += 1 |
| ∘ | Other if-then conditions to capture page structure. | |
| | - | If row has more than 2 elements and first element is “purpose”, we know the next row will |
| | | contain a step-action table. So we will create a Procedure object accordingly. |
| | - | If row has more than 2 elements and GI flag is True, we create GeneralInformation object |
| | | by concatenating elements into a string. |
| | - | Etc. (mostly to capture variations in page structure) |

As can be seen above or otherwise, in some embodiments, the system is configured to process electronic documents which have contextual/semantic information at the beginning of the document. For example, a standard document may have standard lines/rows indicating when the document was modified/updated, table of contents, topic lists, purposes, contexts and other general information of the document; and store this information in respective data structures.

For example, in some situations, multiple documents may have general information sections. When the system identifies the start of such a section when parsing a portion of an electronic document, the system can be configured to set a General Information flag indicating that the following portion of the document being parsed is to be parsed into General Information objects where the first column is the General Information key and the second column is the General Information value.

In some embodiments, when patterns of structural indicators appear in multiple documents, the system is configured to generate new procedures for processing the applicable document portions in a defined manner when they match the pattern of structural indicators.

In some embodiments, the system is configured to recursively or sequentially parse nested structures in the document when it identifies nested structural indicators; for example, inner tables in the document.

The example pseudocode below shows aspects of an example process for recursively parsing nested structures.

Input: the tag (a beautifulsoup element) that contains the inner table
- Get column information:

| | |
|---|---|
| ∘ | Take the first row of the table as table header |
| ∘ | Some tables's first row has less columns than subsequent rows. Count the max number of columns across |
| | all rows, and use the last available column header as the header name. |

- Get texts in table cells:

| | |
|---|---|
| ∘ | Initialize rows = [symbol] |
| ∘ | For row in table rows, starting from second row: |
| | - row = [symbol] |
| | - For cell in row.children: |
| | [symbol] If cell contains a nested table element: |

```
∘ Make a recursive call to create a HtmlTable
  object from the inner table (which
  adds column headers to each cell in each row)
∘ Get formatted text concatenated into a string from the inner table
∘ row += text_extracted
```

[symbol]

If cell does not contain nested table element:

∘ Extract text within cell and do: row += text extracted

| | |
|---|---|
| | - rows += row |
| ∘ | Adjust the index of the column to address tables with multiple multirow cells |

- Create constructs from table

| ∘ | Initialize table_constructs = [symbol] | #stores ProcedureSteps and formatted strings |
|---|---|---|
| ∘ | If column[0] == “step” and | #step/action table |
| | column[1]==”action” : | |
| | - Initiliaze action = “” | |
| | - For row in rows: | |
| | [symbol] For item in rows: | #now we're iterating through the parsed objects |

∘ If item is a HtmlTable object: # contains nested inner table

∘ return all the formatted text concatenated into one string
∘ action += formatted text

∘ Else:

| | ∘ action += text |
|---|---|
| [symbol] step_construct = ProcedureStep(step_index = | #row[0] contains the step index |

| | |
|---|---|
| | row[0], action = action) |
| | [symbol] table_constructs.append(step_construct) |
| ∘ | Else: |
| | - TFormat table output as a string as follows: |
| | - Output_str = “” |
| | - For row in rows: |
| | [symbol] Output_str += ″(″ + <column header> + ″) ″ + <row value> |

As illustrated above or otherwise, in some embodiments, the system is configured to handle tables where different rows have different numbers of columns. In some scenarios, where the table's first row has fewer columns than subsequent rows, the last available column header is used for the additional columns. For example, if a table has max 3 columns, but row one only has 2 columns with header (step, action), the system can apply the last available header name “action” to the remaining columns. So the resulting column names=(step, action, action).

As illustrated above or otherwise, in some embodiments, the system can create structured objects to be used in constructing an augmented electronic document.

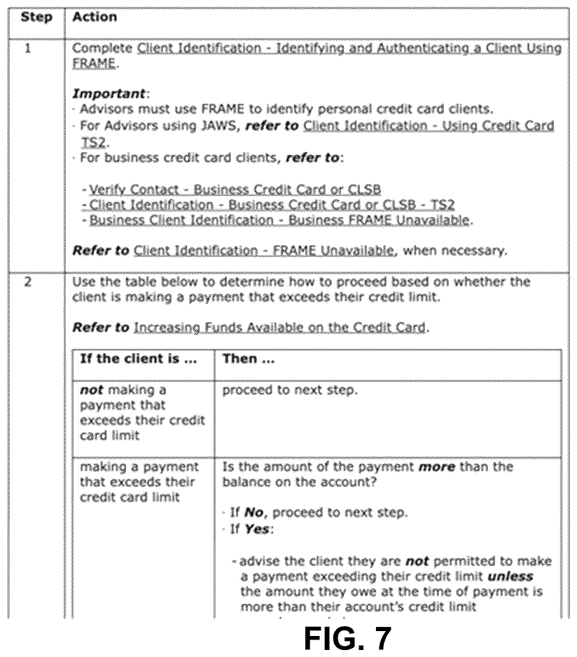

With reference to the example electronic document portion in FIG. 7, the system is configured to make a recursive call which ensures that when a table is converted to text, the table header is appended to each cell, regardless of which level the table is nested. For step/action tables, the system stores a list of ProcedureStep objects, and for all inner tables, the system only obtains formatted text (in this case the text would be: “(if the client is . . . ) not making a payment that exceeds their credit card limit (Then . . . ) proceed to next step. (If the client is . . . ) making a payment that exceeds their credit card limit (Then . . . ) Is the amount . . . )”). For ProcedureStep objects, the text is formatted in a similar way in another python script.

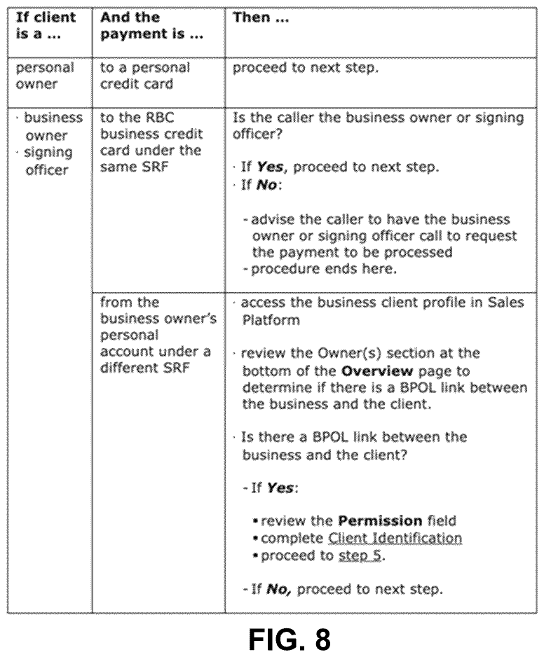

With reference to the example electronic document portion in FIG. 8, parsing this document can be nontrivial because of the varying number of cells per row. When the system counts the number of cells per row, rows 1-3 have 3 cells per row, and row 4 has 2 cells. To capture this, the system is configured to determine that the cell “business owner signing officer” spans 2 rows at the first column. The system then inserts this cell into the first position in the last row. As a result the parsed last row will be [“business owner signing officer”, “from the business owner's . . . ”, “access the” . . . ]. Then when the system adds the table headers to the cells, the information makes sense.

In some embodiments, when parsing of a document is complete (or as the document is being parsed), the system generates a document procedure object which identifies or includes all the procedures to be used to create an augmented electronic document based on the structural indicators and the text of the original document. These procedures define how the text of the original document is combined with stored objects to create augmented text which captures the semantic(s) associated with the structural indicators in the document.

For example, for the following example portion of a document:

Example TABLE 1

| If Client is a . . . | They are eligible for . . . |
|---|---|
| law student | $120000 line of credit |
| accountant | $80000 line of credit |

a generative model may not process the information contained in the table well. Accordingly, based on the processes described above and herein, an example system can parse the above table and generate the following augmented text:

### Example Output for Table 1

If Client is a law student, they are eligible for $120000 line of credit.
If Client is an accountant, they are eligible for $80000 line of credit.

In another example, for the following example portion of a document:

Example TABLE 2

| Step | Action |
|---|---|
| 1 | Verify a client's identity |
| 2 | Determine if the client wants to apply |
| | for a credit card or a credit line |

the system can parse and generate the following augmented text:
Step: 1, Action: Verify a client's identity
Step: 2, Action: Determine if the client wants to apply for a credit card or a credit line

As noted above, the algorithm/method is also applied to sub-tables or nested tables, that is, tables within a larger table. Coherent sentences in natural language will be generated for sub-tables recursively. Additionally, this approach is applied to non-standard tables with cells that span multiple rows.

As illustrated in these examples, in some embodiments, the system is configured to manipulate the electronic document to generate an augmented electronic document encapsulating the semantic information associated with the structure (as identified by structural indicators) of the document.

In some embodiments, generating the augmented electronic document can include generating an augmented electronic document in meaningful segments or blocks that are semantically cohesive and/or relevant.

In standard compiler construction, a sequence of steps within a procedure document is considered a Basic Block (BB) if it has no branches out of it except at the beginning and end of the procedure. In other words, a BB represents a contiguous block of procedural steps that can be executed without interrupting or branching out to another section.

In Dynamic Basic Blocks (DBBs), the system can utilize the concept of BBs and can extend it further by identifying blocks within a procedure document based on metadata and semantic analysis. By utilizing document metadata, DBBs consider various factors such as:
Relevant structural information
Conceptual relationships between sections (e.g., relationship between Document Purpose and individual Procedures)
Step and procedure boundaries

These factors enable DBBs to identify meaningful segments or “blocks” within the procedure document that are semantically cohesive and relevant. This approach allows for a more nuanced understanding of the procedure's structure and content and leads to improved relevance and answer accuracy.

In some embodiments, the system is configured to apply DBBs in the augmented electronic document (for use for example in a Retrieval-Augmented Generation pipeline). In some situations, this can improve retrieval efficiency by focusing on relevant segments rather than scanning the entire document; enhance generation quality by using semantically meaningful segments of the document as input and how it relates to a greater whole; and/or reduce computational complexity by processing smaller, more manageable segments.

The following pseudocode provides an example process for generating an augmented electronic document:

| - | Input: procedure_docs = list of ProcedureDocument objects | | |
|---|---|---|---|
| - | Output: list of DBB objects for embedding creation | | |
| - | DBB-list = [symbol] | | |
| - | For doc in procedure_docs: | | |
| | ∘ For procedure in doc.procedures: | | #each procedure_document may contain 1+ procedures |
| | - | normalized_steps = [symbol] | |
| | - | For step in procedure.steps: | # loop through procedure steps |
| | | [symbol] | Step_text = “Step ” + step_index + “ ” + step.action #construct a sentence |
| | | [symbol] | Step_text_normalized = normalize_text(step_text) # remove extra spaces, non-content |
| | | | text that may appear in an HTML or other document such as “IMAGE”, “MOBILE IMAGE” |
| | | [symbol] | If step_text_normalized > max_passage_size, further chunk the text into several strings. |

| - | Group strings from the same procedure as necessary. E.g. if max_passage_size = 500, and |
|---|---|
| | procedure has chunks of size [100, 200, 200, 300, 400, 50], then the first 3 chunks will be grouped |
| | together. The 4^{th} chunk won't be grouped with anything because that would exceed the maximum |
| | passage size. The resulting chunks will have size: [500, 300, 450]. This grouping ensures we |
| | create blocks with as many steps as possible, while respecting the size of the steps. We also only |
| | perform this grouping within each procedure, so steps from procedure 1 and steps from procedure |
| | 2 won't be grouped together. |
| - | create detailed_purpose using document title, type, category, published date, procedure purpose, |
| | and procedure name. |
| - | Add detailed purpose as a prefix to each step in grouped_steps |
| - | Append purpose_steps to DBB-list |
| ∘ for GI_entry in doc.general_information: | |
| - | GI_text = GI.item + ″ ″ + GI.value #construct sentence |
| - | GI_text_normalized = normalize_text(GI_text) |
| - | create detailed_purpose using document title, type, category, published date. |
| - | Add detailed purpose as a prefix to each step in grouped_steps |
| - | we do not perform grouping of GeneralInformation entries because each one talks about a different |
| | subject. |
| - | Append purpose_GI to DBB-list |
| ∘ If unparsed_text is non-empty: | |
| - | Chunk unparsed_text according to max_passage_size |
| - | create detailed_purpose using document title, type, category, published date. |
| - | Add detailed_purpose as a prefix to each block. |
| - | Append purpose_text to DBB-list |

| | |
|---|---|
| - | Store DBB-list to a file. (The text in each DBB will be embedded and uploaded to a vector database for embedding |
| | search) |

FIG. 2 is a flow diagram illustrating aspects of an example method for data ingestion. In some embodiments, the system provides a natural language processing architecture using a Retrieval Augmented Generation (RAG) pattern. In an example application, source documents such as a library of policy and procedure documents can be retrieved or accessed.

In some embodiments, the system is configured to traverse/parse the documents by:
Parsing each document to extract text and relevant metadata such as published date, document number, and document category.
Break down each procedure document into multiple procedures if relevant.
Extract general information entries.

In some embodiments, the system is configured to generate an augmented electronic document. In some embodiments, this includes transforming tabular procedure documents into a sentence format. In some embodiments, generating the augmented electronic document can include normalization which can include parsing, splitting and grouping text according to step boundaries and tokenization lengths.

In some embodiments, generating the augmented electronic document can include metadata-driven segmentation. This can include partitioning extracted text into document segments for some identifiable types of sections (e.g. policies) or blocks (e.g, procedures).

For example, for one type of document portion (e.g. policies): Document segments can be created using a generic parser, and can be partitioned following a fixed length (e.g. 500) token strategy with the document title prepended as metadata.

For another example, for one type of document portion (e.g, procedures): Dynamic Basic Blocks (DBB) for procedures can be created by partitioning extracted text based on steps boundaries and length of relevant metadata. Blocks may be enhanced with relevant metadata to preserve context and control flow.

In some embodiments, the system is configured to store the augmented electronic document(s) in a vector database. In some embodiments, this can include generating embeddings for segments of the documents.

For example, embeddings can be generated for all document segments and DBB (for policies and procedures, respectively). In some embodiments, multiple models (e.g., GTR T5 XXL, fine-tuned multi-qa-mpnet model, and OpenAI-Ada-002) can be used to support the creation of an Ensemble of Representation Embeddings. The resulting embeddings, their associated DBBs, and the input raw text can all be stored in a database (e.g. Qdrant Vector DB) for retrieval and ranking. In some embodiments, document categories can be used as filters and mapped accordingly into the vector database search space.

Once stored, the embeddings can be used to find information and generate answers in response to queries. As illustrated herein, in some embodiments, the query can be received as an input such as in a query field in a user interface. In other embodiments, queries can be obtained for any other suitable application, e.g. from a question posed to a chatbot, from a request to generate a new document including particular information, etc.

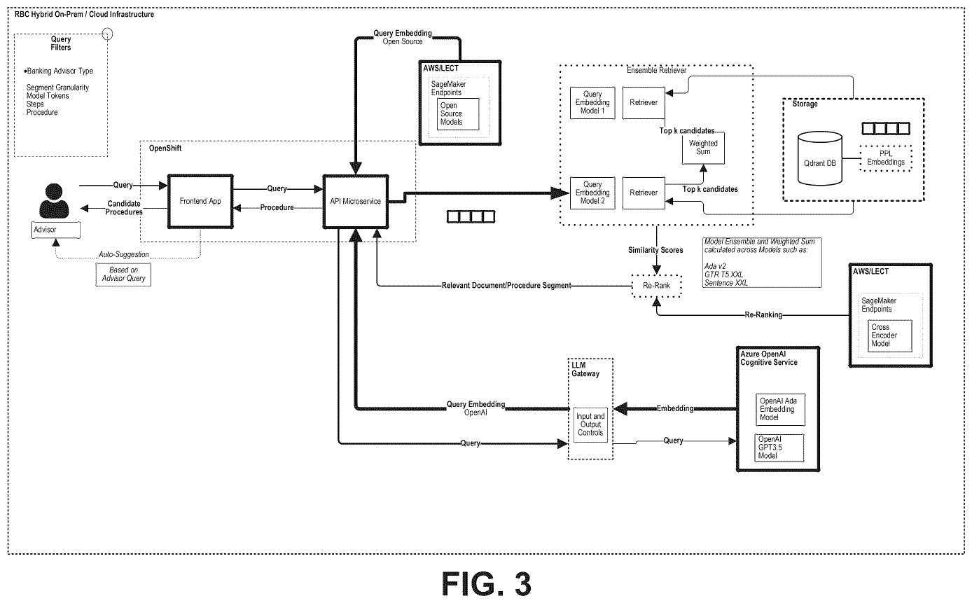

FIG. 3 is a flow diagram illustrating aspects of an example method for retrieving and ranking information from the vector database.

When a query is received from the front-end application, in some embodiments, query embeddings are generated. In some embodiments, a single model or a Model Ensemble approach can be used (e.g. see as described above).

In some embodiments using the Model Ensemble approach, the two models used during this phase can be selected by the user in the UI. Using these query embeddings, the system retrieves relevant document embeddings for the models specified from the Vector DB through vector similarity search (e.g. using cosine similarity for each of the embedding models specified).

In some embodiments, to speed up search and reduce the search space, role filters (associated with the query) can be applied to select document categories mapped into the vector database search space. These candidate results' similarities scores are ranked after applying a weighted scoring mechanism (e.g. as described in the ensemble retrieval described above).

For example, in some embodiments, a user profile or device accessing the system can be associated with one or more roles, such as a banking advisor or a credit advisor. In some embodiments, these roles can be associated with one or more documents categories. For example, a document category may be a line of business such as online banking (OLB), Cards Sales and Services (CSS), at the like. In some embodiments, the user profile or device can be directed associated with a document category.

For example, an electronic document may belong to a single line of business such as CSS which is identified in the metadata of the document or otherwise. When parsing the electronic document, the system can be configured to extract this information and tag the augmented electronic document with it prior to storing it in the vector database. At query inference time, the system can be configured to map the (advisor) user role (e.g., “Credit Advisor”) to a reduced set of documents over which to perform information retrieval (e.g., only documents tagged with “Credit” and “CSS” LOBs).

In some embodiments, weights for each model combination were determined through evaluation on a benchmark ground-truth dataset. For example, weights can be applied as follows: Final Score=Model A Score×Model A Weights+Model B Score×Model B Weights. The top n (e.g ten) candidates can be passed to a re-ranker using a fine-tuned cross encoder model (e.g. hosted on Amazon Sagemaker). A number of results can be passed to the front-end. In some embodiments, the number of results can be based on ranking or can be determined through a control on the UI.

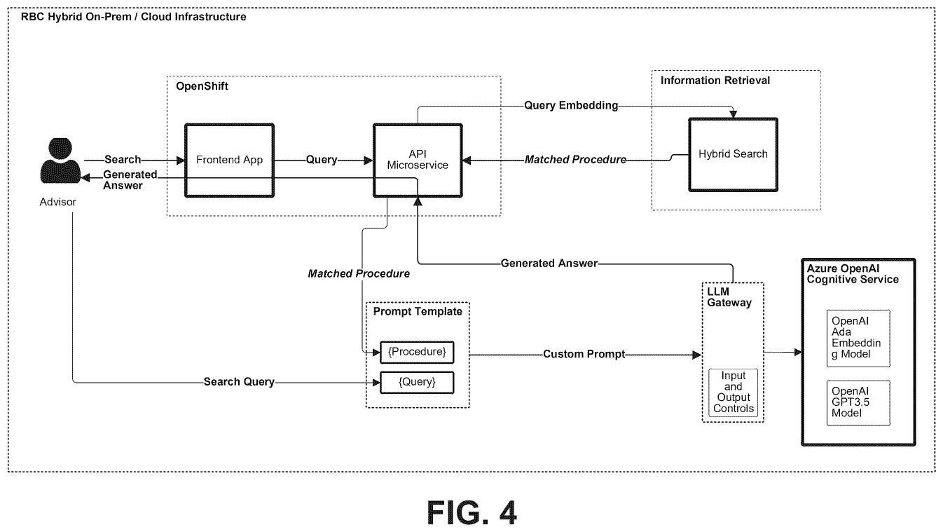

FIG. 4 is a flow diagram illustrating aspects of an example method for generating a response to the query. In some embodiments, the document segments and DBBs from the previous phase are displayed as results in a front-end web client. Additionally, as illustrated in the example user interface in FIG. 5, a generative answer based on the top resulting document segment or DBB can be produced. The underlying raw text for the document segment or DBB is used along with an instruction handcrafted to extract a concise answer if one exists in the segment, or to abstain from providing an answer if it does not exist. In some embodiments, the prompt can be passed to an LLM (e.g. OpenAI GPT-3.5 through an LLM Gateway), and the generated answer is passed back through the LLM gateway to the front-end web client. If the user selects a different document segment in the front-end web client, a new generative answer will be generated based on that segment.

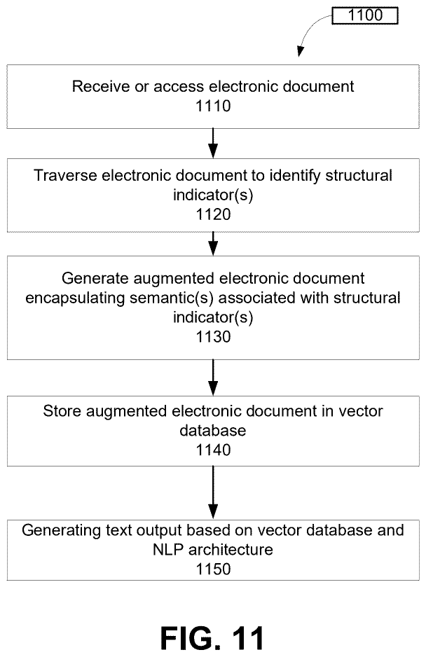

FIG. 11 is a diagram showing aspects of an example 1100 method for a machine learning architecture. In some embodiments, aspects of the method can include any of the technical steps described herein. In some embodiments, aspects of the method can be part of other steps or methods described herein.

As described herein or otherwise, at 1110, the processors are configured to receive or access an electronic document. In some embodiments, the electronic document can be an HTML document, a word processor document, a spreadsheet document, a presentation document, a text document (such as a LaTeX document) or any other document that may include structural indicators.

In some embodiments, the electronic document can be an image or formatted document which includes text such as an image of a text document, a .pdf, and the like. In some embodiments, structural indicators can in these documents can include visual features of the document such as table lines, headings, font sizes, spacings between text, and the like.

In some embodiments, the electronic document is received as a batch of documents for processing. In some embodiments, the electronic document is received as a URL or other file location, and the processors are configured access and retrieve the document via a network, file system and/or database of documents. In some embodiments, the electronic document can be uploaded to the system via a user interface.

As described herein or otherwise, at 1120, the processors are configured to traverse the document to identify structural indicators. In some embodiments, the processors can parse the document portion by portion (e.g. character by character, line by line, chunk by chunk) until it finds a structural indicator. In some embodiments, the processors can segment the document, insert structural indicator tags, and/or extract portions of text associated with the structural indicator.

In some embodiments, structural indicators can be indicative of a page header, and the processors can be configured to parse and store data from the page header in specific metadata fields (e.g. title, document number, document type, date, language, category, etc.).

In some embodiments, structural indicators can be indicative of aspects of a table (e.g. start of a table, first row/column of a table, subsequent rows/columns of a table), and the processors can be configured to store the text data within the table in a data structure indicating whether the text is a table header or from a subsequent row/column of the table.

In some embodiments, when a table or other structural/hierarchical indicator is found, the processors can maintain a state machine to track what section/subsection the following text being parsed is a part of. This can enable proper apportionment and tracking for nested or hierarchical structures (e.g. nested tables, document subsections, etc.).

In some embodiments, the processors are configured to call different functions for parsing associated text when different structural indicators are detected. For example, a different function can be called to parse a table which matches a known format than a function called for a table that does not match any known format, or than a function called for parsing a portion of text following a section heading.

In some embodiments, the text associated with a structural indicator can be stored in a JSON or other data structure.

As described herein or otherwise, at 1120, the processors are configured to generate augmented electronic document text to encapsulate semantics associated with the structural indicators. For example, table text, in some embodiments, the processors are configured to add header text or text generated based on the header row text to the row/column associated with the header.

In some embodiments, document header information text or text generated based on the header information text to portions of the document body text. For example, if a header or other metadata in a document indicates that the document relates to personal banking vs. small business banking, the augmented text can append text to the portions of the document body text.

At 1130, in some embodiments, the augmented electronic document text can be stored in a JSON or other data structures.

In some embodiments, the augmented electronic document text can be stored in segments or blocks which are semantically cohesive. As described herein or otherwise, in some embodiments, the detection of semantically cohesive text can be based on the section of the document in which the text is found as indicated by the structural indicators.

At 1140, in some embodiments, the augmented electronic document text can be ingested into an LLM or RAG, or can be otherwise stored in a vector database for future access/retrieval by a natural language processing architecture.

At 1150, text can be generated based on the vector database which has encapsulated the augmented electronic document. In some embodiments, the generated text can be based on a query received by via a user interface, chatbot, email query, or any other structured or natural language request.

In some embodiments, the augmented electronic document text is stored with links or other metadata for identifying the original electronic document from which the augmented vectors originated. In some embodiments, an output from a query on the database can generate using an LLM or other language model a natural language text response to the query as well as a link or other original document indicator enabling the original document to be accessed for validation and/or reference. See for example, FIG. 5. In some embodiments, multiple responses and/or multiple original documents can be outputted in response to a single query.

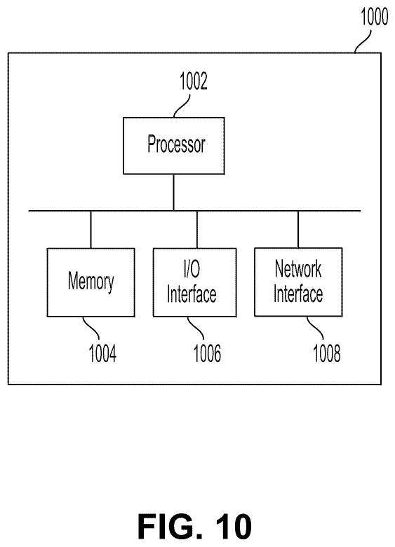

FIG. 10 is a schematic diagram of a computing device 1000, one or more of which may be used to implement various elements of computing systems, architecture, and methods described herein or otherwise.

As depicted, computing device 1000 includes at least one processor 1002, memory 1004, at least one I/O interface 1006, and at least one network interface 1008.

Each processor 1002 may be, for example, any type of general-purpose microprocessor or microcontroller, central processing unit, graphics processing unit, specialize hardware unit (e.g. neural processing unit/AI accelerator/deep learning processor), a digital signal processing (DSP) processor, an integrated circuit, a field programmable gate array (FPGA), a reconfigurable processor, a programmable read-only memory (PROM), or any combination thereof.

Memory 1004 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) and/or the like; as well as hard disk drives, solid-state drives, flash memories, and/or the like.

Each I/O interface 1006 enables computing device 1000 to interconnect with one or more input devices, such as a keyboard, mouse, camera, touch screen and a microphone, or with one or more output devices such as a display screen and a speaker.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1000 is shown but systems may include multiple computing devices 1000. The computing devices 1000 may be the same or different types of devices. The computing devices 1000 may be connected in various ways including directly coupled, indirectly coupled via a network, and distributed over a wide geographic area and connected via a network (which may be referred to as “cloud computing”).

For example, and without limitation, a computing device 1000 may be a server, network appliance, embedded device, computer expansion module, personal computer, laptop, smartphone device, or any other computing device capable of being configured to carry out the methods described herein.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A method for a computer-implemented natural language processing architecture, the method comprising:
receiving or accessing an electronic document;
traversing the electronic document to identify at least one structural indicator associated with a portion of the electronic document;
manipulating the electronic document to generate an augmented electronic document encapsulating a semantic associated with the structural indicator; and
storing the augmented electronic document in a vector database.

2. The method of claim 1 wherein the at least one structural indicator includes at least one of: an indicator indicative of a table; an indicator indicative of a document heading or a section of the electronic document; an indicator indicative of a list of steps or conditions; or an indicator indicative of metadata associated with the electronic document.

3. The method of claim 1, comprising:
identifying a structural indicator indicative of a table, the table including a heading row and at least one non-heading row; and
for each non-heading row of a table, generating augmented text including data from the non-heading row and data from the heading row.

4. The method of claim 3, comprising;
identifying a structural indicator indicative of a multi-level (e.g. nested or sub-tables); and
for each non-heading row of the table, recursively traversing each level of the table to generate augmented text including data from the non-heading row and data from the headings of each corresponding level of the table.

5. The method of claim 1 comprising: identifying one or more structural indicators indicative of a plurality of sections in the electronic document; and
segmenting the electronic document into dynamically-sized basic blocks based at least in part on boundaries between the plurality of sections.

6. The method of claim 1 comprising: generating embeddings for segments of the augmented electronic document using a plurality of models.

7. The method of claim 1 comprising:
receiving a query via a user interface or front-end application;
generating query embeddings based on the text query;
obtaining document embeddings from the vector database based on the query embeddings; and
communicating a query response base on the obtained document embeddings.

8. The method of claim 7 comprising determining a user type associated with the query; and
obtaining document embeddings based at least in part on the user type.

9. A system for a computer-implemented natural language processing architecture; the system comprising:
a processor; and
a non-transitory memory storing one or more sets of instructions that when executed by the processor, configures the processor for:
receiving or accessing an electronic document;
traversing the electronic document to identify at least one structural indicator associated with a portion of the electronic document;
manipulating the electronic document to generate an augmented electronic document encapsulating a semantic associated with the structural indicator; and
storing the augmented electronic document in a vector database.

10. The system of claim 9 wherein the at least one structural indicator includes at least one of: an indicator indicative of a table; an indicator indicative of a document heading or a section of the electronic document; an indicator indicative of a list of steps or conditions; or an indicator indicative of metadata associated with the electronic document.

11. The system of claim 9, wherein the one or more sets of instructions configure the processor for:
identifying a structural indicator indicative of a table, the table including a heading row and at least one non-heading row; and
for each non-heading row of a table, generating augmented text including data from the non-heading row and data from the heading row.

12. The system of claim 9, wherein the one or more sets of instructions configure the processor for:
identifying a structural indicator indicative of a multi-level (e.g. nested or sub-tables); and
for each non-heading row of the table, recursively traversing each level of the table to generate augmented text including data from the non-heading row and data from the headings of each corresponding level of the table.

13. The system of claim 9 wherein the one or more sets of instructions configure the processor for: identifying one or more structural indicators indicative of a plurality of sections in the electronic document; and
segmenting the electronic document into dynamically-sized basic blocks based at least in part on boundaries between the plurality of sections.

14. The system of claim 9 wherein the one or more sets of instructions configure the processor for: generating embeddings for segments of the augmented electronic document using a plurality of models.

15. The system of claim 9 wherein the one or more sets of instructions configure the processor for:
receiving a query via a user interface or front-end application;
generating query embeddings based on the text query;
obtaining document embeddings from the vector database based on the query embeddings; and
communicating a query response base on the obtained document embeddings.

16. A non-transitory computer-readable medium or media having stored thereon machine interpretable instructions which, when executed by a processing system, configure the processing system for:
receiving or accessing an electronic document;
traversing the electronic document to identify at least one structural indicator associated with a portion of the electronic document;
manipulating the electronic document to generate an augmented electronic document encapsulating a semantic associated with the structural indicator; and
storing the augmented electronic document in a vector database.

17. The computer-readable medium or media of claim 16, wherein the at least one structural indicator includes at least one of: an indicator indicative of a table; an indicator indicative of a document heading or a section of the electronic document; an indicator indicative of a list of steps or conditions; or an indicator indicative of metadata associated with the electronic document.

18. The computer-readable medium or media of claim 16, wherein the instructions configure the processing system for:
identifying a structural indicator indicative of a table, the table including a heading row and at least one non-heading row; and
for each non-heading row of a table, generating augmented text including data from the non-heading row and data from the heading row.

19. The computer-readable medium or media of claim 16, wherein the instructions configure the processing system for:
identifying a structural indicator indicative of a multi-level (e.g. nested or sub-tables); and
for each non-heading row of the table, recursively traversing each level of the table to generate augmented text including data from the non-heading row and data from the headings of each corresponding level of the table.

20. The computer-readable medium or media of claim 16, wherein the instructions configure the processing system for:
receiving a query via a user interface or front-end application;
generating query embeddings based on the text query;
obtaining document embeddings from the vector database based on the query embeddings; and
communicating a query response base on the obtained document embeddings.
